(19) United States
(12) Patent Application Publication
(10) Pub. No.: US 2008/0238665 A1
(43) Pub. Date: Oct. 2, 2008

(54) SENSORY FEEDBACK SYSTEMS FOR NON-CONTACT ELECTRICAL SWITCHES

(76) Inventor: Robin Peng, South Jordan, UT (US)

Correspondence Address: GEOFFREY E. DOBBIN, PATENT ATTORNEY, 4278 SOUTH 6220 WEST, WEST VALLEY CITY, UT, 84128-6501, US

(21) Appl. No.: 11/958,358

(22) Filed: Dec. 17, 2007

Related U.S. Application Data
(60) Provisional application No. 60/870,239, filed on Dec. 15, 2006.

(51) Int. Cl. H01H 31/00

(52) U.S. Cl. 340/540; 200/237

(57) ABSTRACT

The present invention relates to sensory feedback for non-contact electrical switching systems. Such systems may be used in conventional electrical circuits or in traditionally non-electrical switching systems, such as faucets. The non-contact electrical switching mechanism includes a motion sensor to detect motion for the purpose of changing between an on and an off state. The sensory feedback system is physically disposed on the non-contact electrical switching mechanism in proximity to the motion sensor and is configured to transmit sensory data corresponding to the current state of the non-contact switching mechanism. Sensory data is data which is received by one or more of the five human senses. The sensory data may include continuous, responsive, and/or synchronized sensory feedback. It will be appreciated that teachings of the present invention may be applied to other forms of human interface non-contact switching mechanisms such as those responding and/or detecting human generated sound, thoughts, etc.

### CROSS-REFERENCES TO RELATED APPLICATIONS

This application claims priority on prior filed U.S. Provisional Application No. 60/870,239, filed on Friday, Dec. 15, 2006 and incorporates the same in its entirety herein.

### FIELD OF THE INVENTION

The invention generally relates to non-contact electrical switching systems. In particular, the present invention relates to an improved sensory feedback system for noncontact electrical switches.

### BACKGROUND OF THE INVENTION

Numerous non-contact or non-contact electrical switches are currently sold which enable users to change the electrical state of one or more devices without physically contacting the electrical device or switching mechanism. This type of switching mechanism has become preferable in many environments including unsanitary/ultra-sanitary environments, static free environments, high voltage devices, and moist electrical environments. Various technologies exist to enable the electrical switching without requiring physical contact between the user and the switching mechanism. These technologies include both audio sensing and non-contact technologies. One audio sensing device known by the brand name of THE CLAPPER™ is configured to activate an electrical switching mechanism in response to the sound of a user's hands clapping. Various types of non-contact devices are configured to switch an electrical switching mechanism in response to a user performing some form of movement in view of the switching mechanism. These are, however, usually mounted directly on the device needed to be activated and tend to activate on either non-directed motion (e.g. automatic faucets) or do not need to be intentionally toggled between on and off states (e.g. paper towel and soap dispensers).

One of the problems associated with conventional non-contact switching mechanisms is the non-intuitive manner in which a user must determine the current electrical state of the switching mechanism and/or any output devices coupled to the switching mechanism. For example, a motion sensitive non-contact switching device requires a user to perform some form of motion in view of the device to change its electrical state. However, the required location of the non-contact is often inconsistent with the location at which a user determines the current electrical state of the switching mechanism and/or the output device. In a residential scenario, if the non-contact switch is connected to an outside patio light, a user must be in a position to view the state of the patio light and then perform the required motion in view of the switch to change the electrical state of the patio light. Numerous non-contact switches attempt to overcome this problem by expanding the region in which motion or sound is detected. Unfortunately, this solution introduces further problems related to undesired or erroneous switching in which the noncontact switch changes electrical state in response to an unintended motion or sound.

Therefore, there is a need in the industry for systems and methods that enable a non-contact switch to coordinate current electrical state information with the required non-contact actions but without introducing excessive erroneous switching. This is particularly true with switches designed to alternate between on and off states, switches with intermediate states, and multiple option switches (e.g. single throw, double pole), where user interaction is used to toggle the state of the switch between two or more states and users need to know what state the switch is in.

### SUMMARY OF THE INVENTION

The present invention relates to non-contact electrical switching systems. One embodiment of the present invention relates to a non-contact electrical switching system including an electrical input, electrical output device, a non-contact electrical switching mechanism, and a sensory feedback system. The non-contact electrical switching system is connected to both the electrical input and electrical output device such that in an on state, the electrical output device is electrically connected to the electrical input and in an off state, the electrical output device is electrically disconnected from the electrical input. The non-contact electrical switching mechanism also includes a motion sensor to detect motion for the purpose of changing between the on and off state. The sensory feedback system is physically disposed on the non-contact electrical switching mechanism in proximity to the motion sensor. The sensory feedback system is configured to transmit sensory data corresponding to the current state of the non-contact switching mechanism. Sensory data is data which is received by one or more of the five human senses. The sensory data may include continuous sensory feedback, responsive sensory feedback, and/or synchronized sensory feedback. Continuous sensory feedback is continuously transmitted regardless of the location of a user, the electrical state of the non-contact switch, etc. Responsive sensory feedback is transmitted in direct response to a change in state of the non-contact switching mechanism. Synchronized sensory feedback is transmitted during the course of changing the state of the non-contact switching mechanism. It will be appreciated that teachings of the present invention may be applied to other forms of human interface non-contact switching mechanisms such as those responding and/or detecting human generated sound, thoughts, etc.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The following description of the invention can be understood in light of the Figures, which illustrate specific aspects of the invention and are a part of the specification. Together with the following description, the Figures demonstrate and explain the principles of the invention. The Figures presented in conjunction with this description are views of only particular—rather than complete—portions of the systems and methods of making and using the sensory feedback system and method according to the invention. In the Figures, the physical dimensions may be exaggerated for clarity. The same reference numerals in different drawings represent the same element, and thus their descriptions will be omitted.

FIG. 1a illustrates a visual representation of a sensory feedback system in accordance with a prior art physical toggle switch.

FIG. 1b illustrates a visual representation of a sensory feedback system in accordance with a prior art non-contact electrical switch.

FIG. 1c illustrates a visual representation of a sensory feedback system in accordance with one embodiment of the present invention.

FIG. 2 illustrates a method for human interface electrical switching in accordance with embodiments of the present invention, in contrast with a prior art method utilized by conventional non-contact switching systems which require status information to be obtained from an output device;

FIG. 3 illustrates a detailed process for receiving sensory feedback from a noncontact switching device in accordance with embodiments of the present invention; and

FIG. 4 illustrates a process of receiving three different forms of sensory feedback in connection with a non-contact switching device in accordance with embodiments of the present invention.

FIG. 5 illustrates the prior art process of obtaining sensory feedback from a touchless switch.

FIGS. 6a-6d are side view depictions of a user interfacing with a motion sensitive switch with sensory feedback according to the present invention, with close up plan views of the switch, where 6a depicts a user approaching the switch, 6b depicts the user of FIG. 6a activating said switch, 6c depicts the user opening the switch, and 6d depicts the user closing the switch.

FIGS. 7a-7f are perspective views of a faucet, equipped with non-contact motion sensitive switches with sensory feedback according to the present invention. FIG. 7a illustrates an off state for both volume and temperature switches. FIG. 7b depicts a user turning on the faucet. FIG. 7c depicts the user adjusting water volume. FIGS. 7d and 7e depict the user adjusting water temperature and FIG. 7f depicts the user turning the faucet off.

### DETAILED DESCRIPTION OF THE INVENTION

The present invention relates to non-contact electrical switching systems. One embodiment of the present invention relates to a non-contact electrical switching system including an electrical input, electrical output device, a non-contact electrical switching mechanism, and a sensory feedback system. The non-contact electrical switching system is connected to both the electrical input and electrical output device such that in an on state, the electrical output device is electrically connected to the electrical input and in an off state, the electrical output device is electrically disconnected from the electrical input. The non-contact electrical switching mechanism also includes a motion sensor to detect motion for the purpose of changing between the on and off state. The sensory feedback system is physically disposed on the non-contact electrical switching mechanism in proximity to the motion sensor. The sensory feedback system is configured to transmit sensory data corresponding to the current state of the non-contact switching mechanism. Sensory data is data which is received by one or more of the five human senses. The sensory data may include continuous sensory feedback, responsive sensory feedback, and/or synchronized sensory feedback. Continuous sensory feedback is continuously transmitted regardless of the location of a user, the electrical state of the non-contact switch, etc. Responsive sensory feedback is transmitted in direct response to a change in state of the non-contact switching mechanism. Synchronized sensory feedback is transmitted during the course of changing the state of the non-contact switching mechanism. It will be appreciated that teachings of the present invention may be applied to other forms of human interface non-contact switching mechanisms such as those responding and/or detecting human generated sound, thoughts, etc.

The following terms are defined as follows:

“Non-contact electrical switches” are any type of human interface non-contact switching mechanism that utilizes detected motion to change between electrical states. Non-contact electrical switches may be used in any electrical circuit and may also be used in traditionally non-electrical contexts (e.g. non-touch faucets). The switches depicted in this Application are similar in function to those described in U.S. Pat. No. 7,115,856, issued Oct. 3, 2006 to the present Applicant and Inventor. This patent is incorporated in its entirety herein by reference.

“Directed motion” is motion, detected by a non-contact electrical switch, that is primarily intended to interact with said switch, e.g. intentionally placing one's hand in front of a motion sensitive switch in preparation to activate said switch.

“Non-directed motion” is motion that is incidentally detected by a motion sensitive non-contact electrical switch and is not primarily directed to interact with said switch, e.g. walking into a room with a simple motion sensitive light switch.

“Electrical state” is a state of electrical connectivity such as ON or OFF, or an intermediate state between ON and OFF.

“Sensory feedback” is a form of human received information over one of the five human sensory channels including visual, audible, tactile, taste, and olfactory. Sensory Feedback, as used in this application, does not include the activation/deactivation of a device connected to a non-contact motion sensitive switch, the activation/deactivation of such device being the primary purpose of using the switch (e.g. sensory feedback does not include the actual light turned on by the activation of a non-contact motion sensitive switch).

“Continuous sensory feedback” is a form of sensory feedback which is continuously transmitted.

“Responsive sensory feedback” is a form of sensory feedback which is transmitted in direct response to a particular event.

“Synchronized sensory feedback” is a form of sensory feedback which is transmitted during the course of or in synchronization with a specific action.

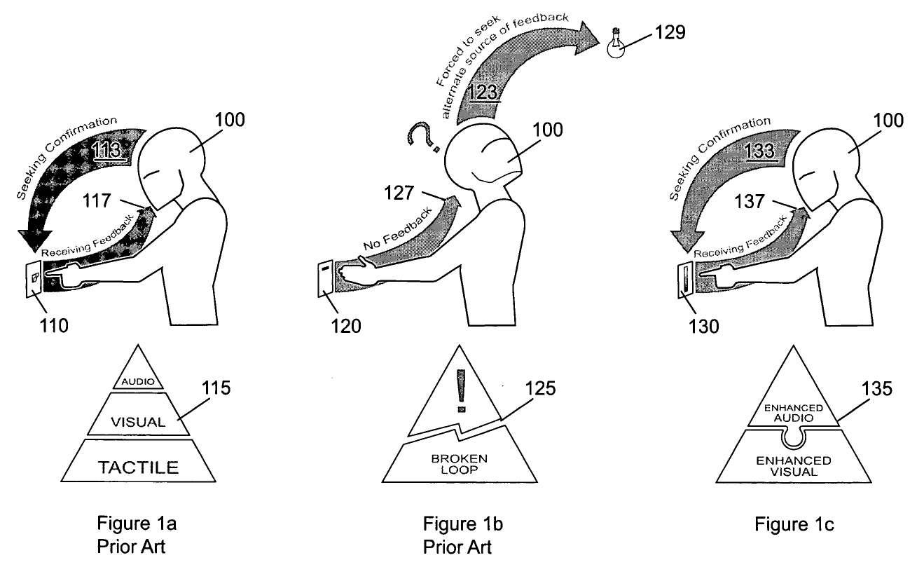

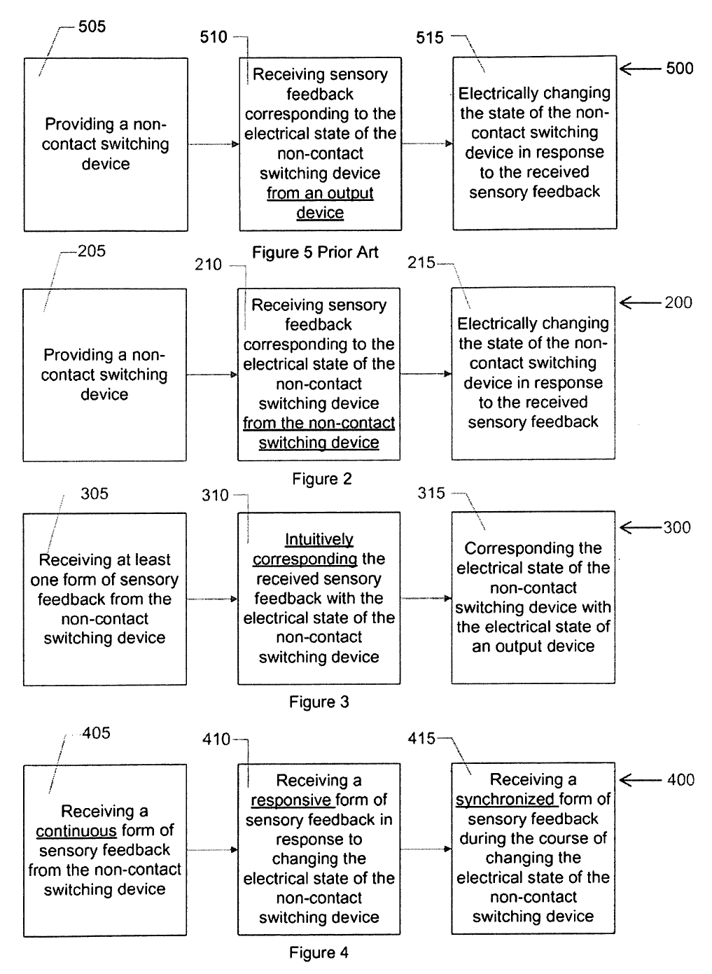

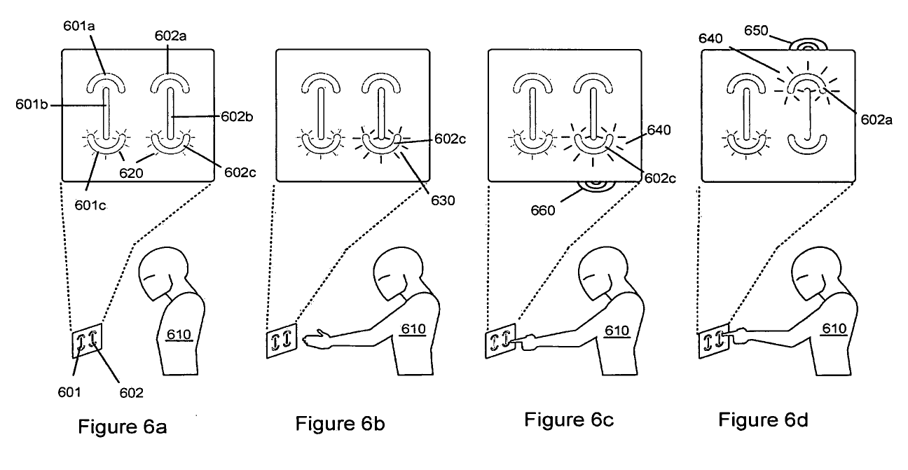

Reference is initially made to FIG. 1, which illustrates a visual representation of a sensory feedback system in accordance with one embodiment of the present invention. This is illustrated in contrast to a prior art physical toggle switch and a prior art non-contact switch. The images illustrate the feedback systems of two prior art switching mechanisms in contrast with a feedback system consistent with teachings of the present invention. The first illustration, FIG. 1a, represents a conventional physical contact based toggle switch 110 in which a user 100 physically switches a toggle bar up or down to change the electrical state between on and off. When the toggle bar is up, the electrical state is on, and vice versa. Users 100 have become aware of this positional relationship such that they can immediately determine the electrical state of a physical toggle switch upon inspection. If this fails, most toggle switches actually have the terms “ON” and “OFF” on the toggle bar. Likewise, the toggle switch creates a sound when it is disposed in either the on or off positions. This then creates three different sensory feedback confirmations that a switch has been activated or deactivated, illustrated in pyramid 115. So the user 110 looks at the switch 113 for confirmation and receives tactile, visual, and audio feedback from the switch 117 to confirm the switch's on or off position.

This is in contrast to the feedback system illustrated for convention non-contact human interface switches, FIG. 1b, which require that a user inspect an output device (in this case a light bulb 129) to determine the electrical state of the switch 120. The feedback location is therefore remote from the location required to change the state of the switch, thereby breaking the illustrated loop. In this illustration, the user 100 activates or deactivates the switch 120, but it is incapable of sending feedback to the user 110 directly 127. As a result, the user 110 is forced to look to the desired device 129 when he searches for confirmatory feedback 123. If the device 129 (light in this case) does not activate, then the user 100 is left with the chore of determining if he did, in fact, activate the switch 120, or if the device 129 is broken, or if there is some other break in the electric current. This break in the sensory loop is depicted in pyramid 125.

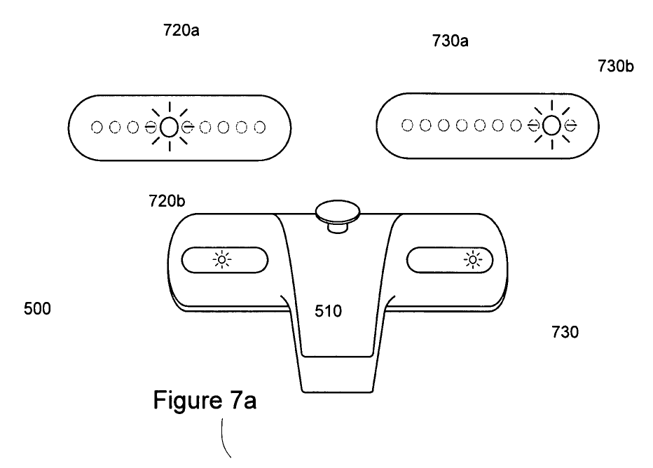

The final image, FIG. 1c, illustrates a non-contact switch with a feedback system in accordance with embodiments of the present invention. The feedback system is located in proximity to the motion sensor of the switch thereby maintaining the feedback loop. The details of the feedback system will be described in reference to FIGS. 2-4. However, in summation, the user 110 activates the switch 130 and searches for feedback 123, which is received from the switch 130 itself 137. Feedback in the illustrated case could be an indicator light coupled with a confirmatory sound, as shown in the pyramid 135.

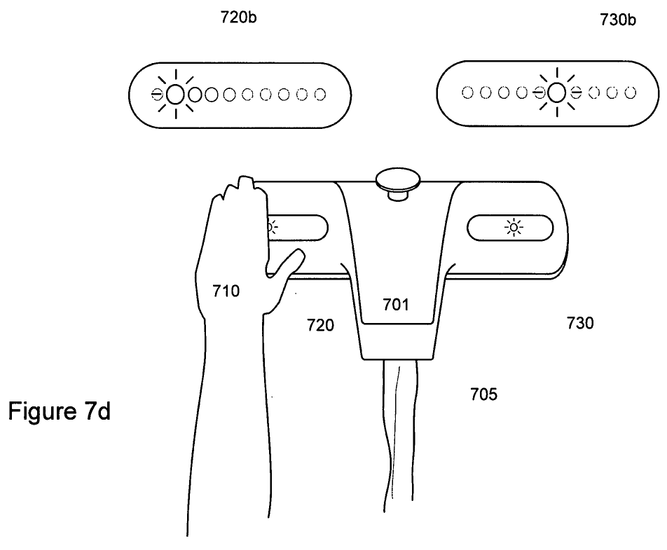

Reference is next made to FIG. 2, which illustrates a method for human interface non-contact electrical switching in accordance with embodiments of the present invention, designated generally at 200. This process may also be referred to as a non-contact electrical switching feedback loop in that the user provides an input to the switch in response to feedback data received from the switch. In contrast, a prior art method utilizing a conventional non-contact switching device and feedback system is illustrated in FIG. 5 and designated as 500, above, wherein the method requires status information to be obtained from an output device, act 510. Initially, a non-contact human interface based switching device is provided. These devices are well known in the industry, and any one may be utilized in conjunction with the illustrated method, act 205. The human user then receives sensory feedback, corresponding to the electrical state of the non-contact switching device, from the non-contact switching device itself and/or from a location in proximity to the non-contact switching device, act 210. For example, if the non-contact switching device is in the form of a wall mounted panel, the received feedback will originate from a location in proximity to the wall mounted panel. The human user then electrically changes the state of the non-contact switching device in response to the received sensory feedback, act 215. For example, the user receives sensory feedback which indicates that the switch is off and performs the necessary action to change the state of the non-contact switching device. The action required to change the state of the non-contact switching device is detected from a location consistent with the origination of the received feedback.

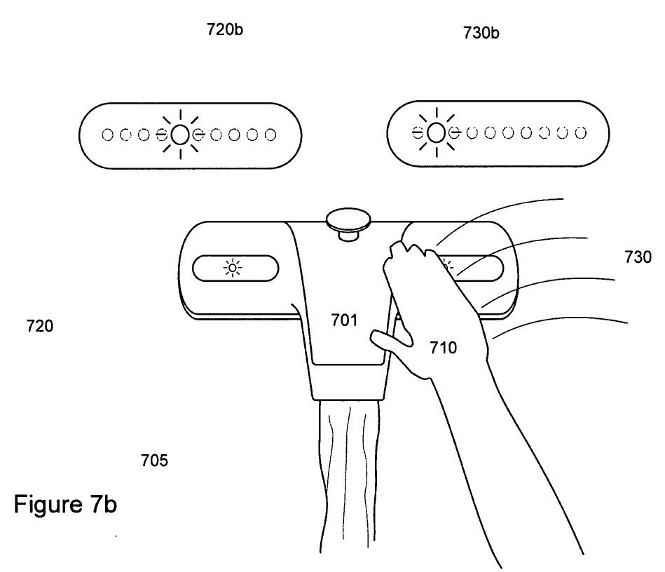

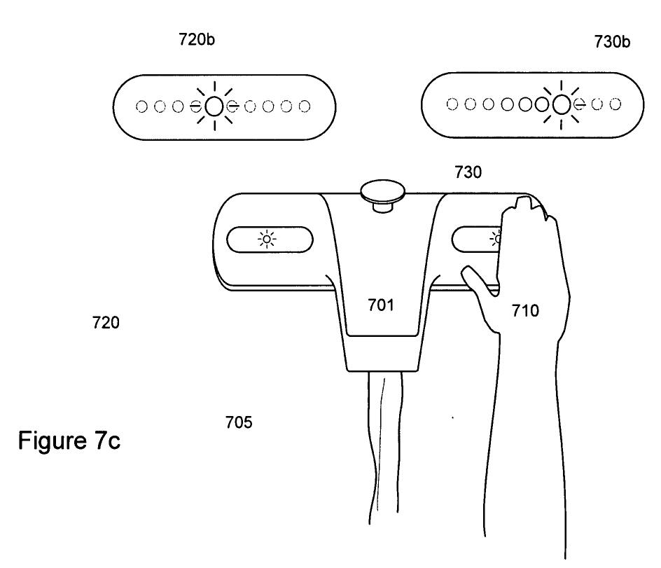

Reference is next made to FIG. 3, which illustrates a detailed process for receiving sensory feedback from a non-contact switching device in accordance with embodiments of the present invention, designated generally at 300. The process includes receiving at least one form of sensory feedback from the non-contact device, act 305. Various forms of sensory feedback are possible and will be described in more detail with reference to FIG. 4. The user intuitively corresponds the received sensory feedback with the electrical state of the non-contact switching device, act 310. This intuitive correspondence is possible by utilizing intuitively known switching and/or electrical sensory related data when providing the sensory feedback to the user. For example, it may be determined that a user intuitively corresponds higher pitched audible data with an electrical switch on state. The user corresponds the electrical state of the non-contact switching device with the electrical state of an output device, act 315. Therefore, the receipt of sensory feedback provides a user with information about the electrical state of the output device while maintaining an optimal single location interface.

Reference is next made to FIG. 4, which illustrates receiving three different forms of sensory feedback in connection with a non-contact switching device in accordance with embodiments of the present invention. Although illustrated together, any one of the specified forms of sensory feedback may be utilized in connection with a non-contact electrical switching process in accordance with embodiments of the present invention. A user may receive continuous sensory feedback from the non-contact switching device, act 405. Continuous sensory feedback is continuously transmitted to a user from the non-contact switching device. A user may receive responsive sensory feedback from the non-contact switching device, act 410. Responsive sensory feedback is transmitted to a user in response to the non-contact electrical switching device changing electrical state. A user may also receive synchronized sensory feedback from the non-contact switching device, act 415. Synchronized sensory feedback is transmitted to a user in a time synchronized manner while the non-contact switching device is changing electrical state.

Various single or multi-sensory mediums of sensory feedback may be practiced in accordance with embodiments of the present invention. For example, a visual sensory medium may be included as continuous sensory feedback system in the form of a continuously displayed vertical light. The continuous sensory feedback alerts a user to the presence of the switch and its powered but dormant state. In this example, an upward location corresponds to an on state due to a user's intuitive association with a physical toggle switch's physical positioning (i.e. up is on, down is off). Likewise, an audible sensory medium may be included in a responsive and/or synchronized form. In addition, a simulated tactile medium may be included in a synchronized form, such as a simulated tactile feel of switching a physical toggle switch generated via an electro-magnetic field. Further, an emotional state may be induced in a responsive or synchronized for utilizing an electro-magnetic field. Numerous sensory data transmission formats are well known in the industry and may be incorporated and positioned with a non-contact switching mechanism to provide an efficient sensory feedback system in accordance with embodiments of the present invention. Such systems include and are not limited to LED and other lighting displays, audio playback, scent dispensers, and electro-magnetic field generators. Various other embodiments of the present invention have been contemplated and may be practiced in accordance with the present invention. For example, feedback systems and non-contact human interface switching mechanisms may utilize any combination of the five human senses for purposes of transmitting feedback data to a user and for receiving instructions to change the electrical state of the switching mechanism.

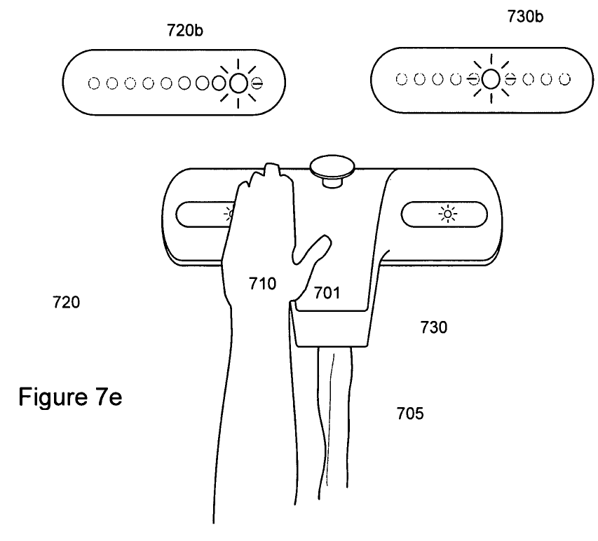

As an example, shown in FIGS. 6a-6d, two non-contact electrical switches 601, 602, are shown, each comprising three windows, upper rocker 601a, 602a, bar 601b, 602b, and lower rocker 601c, 602c. A user 610 desires to activate the right switch 602 in order to turn on a light. The user 610 places his hand in front of the switch 602 and the switch's motion sensor detects the motion as directed motion and causes the switch to increase in brightness, responsive feedback signifying a change from a dormant mode to an active mode. In this example, only lower rocker 602c is amplified, denoting an off state of the switch. This is shown in FIG. 6b. The sensors are positioned so that left switch 601 reads the motion as non-directed motion and remains in dormant mode. It should be noted that in dormant mode, the switches 601, 602 glow with a low level light, continuous sensory feedback depicted by small rays 620. Once activated, switch 602 glows with a more intense light, depicted by medium rays 630. Once interaction is established and switch 602 is in active mode, the user waves his hand upward (FIG. 6d) in front of switch 602. The motion sensor for switch 602 recognizes this motion and both closes the switch (an on state) and lights the upper rocker 602a of the switch 602 with a brighter light, depicted by large rays 640. The switch also, then, plays a recorded “knock” sound, indicated by sound waves 650. In so doing, the switch is activated and the user is able to determine that he was able to activate the switch. This is another example of responsive sensory feedback. If the intended device does not activate, the user 610 can then be sure there is some other fault in the system (e.g. a burnt out light bulb), rather than a failure in switch reception. To turn the device off, the user places his hand in front of the switch and moves his hand down (FIG. 6c), causing the switch to open (off state) and to light up the lower rocker 602c of switch 602, depicted with large rays 640, another sound, which may be the same or different sound as used before and indicated by waves 660, accompanies this operation. The sensors described in this example are described as if they were programmed to only respond to directed motion that mimics the activation of a traditional toggle switch, said directed motion mimicking the duration, direction and proximity of the traditional motion. There are, however an unlimited number of options of motions the sensors may detect for activation/deactivation of the switch. Likewise, there is an unlimited number of sensory feedback indication paradigms that may be used—this example is but one of myriad.

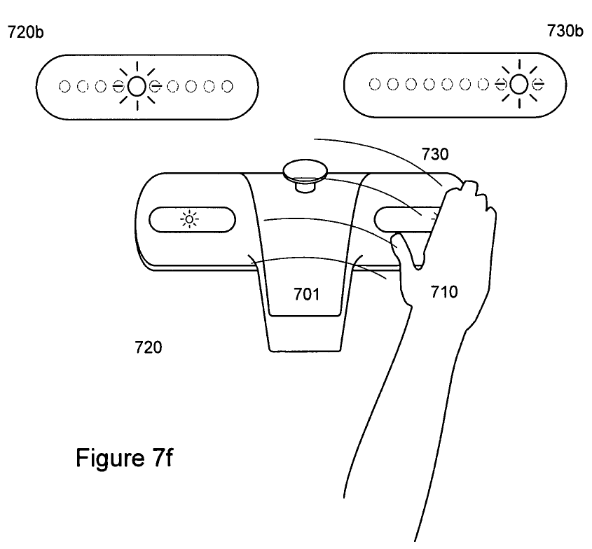

For a continuous operation, a graduated feedback system may be used. This paradigm may be utilized for temperature control (thermostats or running water), ambient lighting level, sound volume or any other situation where a relative increase or decrease from a current state is desired. These systems are ideal uses of synchronous sensory feedback. As a directed motion is targeted at a non-contact electrical switch, it may direct the switch to incrementally change an environmental value, such as ambient temperature, and a display to indicate that change. An example of this type of control may be found in a touchless water faucet, depicted in FIGS. 7a-7f. Faucet 701 is equipped with two sensor windows 720 and 730. Each window covers a plurality of LEDs, 720a, 730a, of which one is lit 720b, 730b. The lit LEDs provide continuous sensory feedback to the user and indicate both system readiness and default water temperature. In this example, in FIG. 7a, window 720 houses a switch to control temperature, and the position of lit LED 720b indicates a lukewarm, middle, temperature. Window 730 houses the on/off/volume switch, and the position of lit LED 730b indicates that it is off. In FIG. 7b, user 710 swipes his hand over window 730, towards the center of the faucet 701. This changes the switch to an on state and turns on the water 705. The far left LED becomes the lit LED 730b, to indicate the faucet 701 is fully on, as shown by the volume of water 705. To control the flow of water 705, shown in FIG. 7c, the user 710 then holds his hand over the window 730 and away from the center of the faucet 701. This incrementally changes the state of the switch to an intermediate on/off state and lessens the flow of water 705. Synchronous sensory feedback is provided in the form of LEDs 730a sequentially lighting and extinguishing until the lit LED 730b and water flow correspond to a desired level. Water temperature is similarly adjusted (FIGS. 7d and 7e) by user 710 holding his hand over window 720, either away from (FIG. 7d) or proximate (FIG. 7e) the center of faucet 701. LEDs 720a synchronously light and extinguish as water temperature changes to hot (FIG. 7d) or cold (FIG. 7e), until a desired temperature, with a corresponding lit LED 720b, is reached. To turn off faucet 701, the user swipes his hand over window 730, originating near the center of faucet 701 (FIG. 7f). The faucet's default temperature and water volume settings could be modified to the user's tastes easily by programming the switches connected to the sensors behind the windows. This is, of course, another example of the many forms of synchronous sensory feedback may be utilized with non-contact switching systems.

Another feature of ambient environmental control is the personalization of the system and, consequently, the controlled environment. As such, a user may access the software running the system and adapt the system's behavior to fit personal tastes. This could include something as simple as directing sounds to be played when switches are activated (e.g. a click, the words “On” and “Off”, Etc.) to running an entire program to enhance the mood in a particular room though sounds, lighting and temperature. Access may be accomplished through a networked computer or remote control device. The system may utilize similar sensory feedback to indicate programming is occurring.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A non-contact electrical switch system comprising:
a. an electrical input;
b. an electrical output device;
c. a non-contact electrical switching mechanism physically electrically coupled to both the electrical input and the electrical output device such that when the non-contact electrical switching mechanism is in an on state, the electrical output device is electrically coupled to the electrical input, and when the noncontact electrical switching mechanism is in an off state, the electrical output device is disconnected from the electrical input, and wherein the non-contact electrical switching mechanism includes a motion sensor configured to only detect and only react to directed motion; and
d. a sensory feedback system disposed on the non-contact electrical switching mechanism so as to be in proximity to the motion sensor,
wherein the sensory feedback system is configured to transmit sensory data corresponding to the current state of the non-contact electrical switching mechanism including at least one of continuous sensory feedback, responsive sensory feedback, and synchronized sensory feedback.

2. The non-contact electrical switch system of claim 1, wherein the sensory feedback system transmits continuous visual data corresponding to the current state of the noncontact electrical switching mechanism.

3. The non-contact electrical switch system of claim 2, wherein the visual data is in the form of a vertically oriented illuminated display in which a substantially upward illuminated display corresponds to an on state of the non-contact electrical switching mechanism, and a substantially downward illuminated display corresponds to an off state of the non-contact electrical switching mechanism.

4. The non-contact electrical switch system of claim 1, wherein the sensory feedback system transmits responsive audible data corresponding to the current state of the non-contact electrical switch in direct response to the changing of the electrical state of the non-contact electrical switching mechanism.

5. The non-contact electrical switch system of claim 1, wherein the sensory feedback system transmits synchronized simulated tactile data corresponding to the current state of the non-contact electrical switch in direct response to the changing of the electrical state of the non-contact electrical switching mechanism.

6. The non-contact electrical switch system of claim 1, wherein the non-contact electrical switching mechanism further includes a non-contact electrical toggle switch, comprising: an electronic switching element; a motion detection element configured to detect two independent movements which mimic the movements required to physically switch a conventional toggle switch, wherein the mimicking includes the movement characteristics of duration, direction, and distance; and if the motion detection element detects one of the two movements, causing the electronic switching element to switch between a first and second electrical state in a manner which corresponds to only how a conventional toggle switch would operate in response to the detected movement, wherein the first electrical state corresponds to an electrical on state and the second electrical state corresponds to an electrical off state.

7. The non-contact electrical switch system of claim 1, the sensory feedback provided being capable of reception by at least two human senses.

8. The non-contact electrical switch system of claim 1, the feedback system providing synchronous feedback in co-relation to the switch changing incrementally between on and off phases.

9. The non-contact electrical switching system of claim 1, the system being programmable for individual customization of the switch's behavior.

10. The non-contact electrical switching system of claim 9, the feedback system providing sensory feedback while the switching system undergoes an act of programming.

11. A method of providing sensory feedback for a non-contact electrical switch, the method comprising the steps of:
a. Providing a sensory feedback system in proximity to a motion sensor for the non-contact electrical switch, the sensory feedback system capable of delivering sensory feedback receivable by one or more human senses;
b. Having the feedback system provide sensory feedback corresponding to a default electrical state for the switch;
c. Having the feedback system provide feedback corresponding to the switch changing from the default electrical state to another electrical state; and
d. Having the feedback system provide feedback corresponding to the switch changing back to the default electrical state.

12. The method of claim 11, the switch being capable of changing electrical states only in response to directed motion.

13. The method of claim 11, the feedback system providing sensory feedback o-relating to incremental changes in the switch's electrical state.

14. The method of claim 11, the sensory feedback provided being directed to at least two different human senses.

15. The method of claim 11, the sensory feedback being selectable from a given set of possible feedback options.

16.
